(19) United States
(12) Patent Application Publication
(10) Pub. No.: US 2021/0298292 A1
(43) Pub. Date: Sep. 30, 2021

(54) BIOAVAILABLE MINERALS FOR THE MITIGATION OF PATHOGENS IN PLANTS

(71) Applicant: Paul R. Simpson, Granite Falls, WA (US)

(72) Inventor: Paul R. Simpson, Granite Falls, WA (US)

(21) Appl. No.: 17/031,889

(22) Filed: Sep. 24, 2020

(30) Foreign Application Priority Data
Mar. 31, 2020 (AU) 2020900979
Sep. 7, 2020 (AU) 2020230231

(51) Int. Cl. A01N 25/22; A01N 59/16; A01N 59/20; A01N 59/00; C05D 9/00; C05C 3/00; C05G 1/00

(52) U.S. Cl. CPC A01N 25/22; A01N 59/16; A01N 59/20; C05G 1/00; C05D 9/00; C05C 3/00; A01N 59/00

(57) ABSTRACT

Plants with mineral deficiencies become viable to pathogen attack. An improved method of treating mineral deficiencies is therefore provided. Bioavailable minerals are provided in a liquid complex such as a pharmaceutically acceptable carrier including water. The composition for use in the method may include other supporting plant nutrients such as botanical extracts, urea, plant hormones, vitamins, and mineral supplements necessary for plant heath.

### CROSS-REFERENCE TO RELATED APPLICATION

This application claims priority from and benefit of the filing date of: (i) Australian Provisional Patent Application No. 2020900979 filed Mar. 31, 2020; and (ii) Australian Patent Application No. 2020230231 filed Sep. 7, 2020; and the entire disclosure of each of said prior applications is hereby expressly incorporated by reference into the present specification.

### FIELD OF THE INVENTION

The present invention relates to plants with mineral deficiencies that are viable to pathogen attack including insects, parasites, fungus, viruses, and bacteria. An improved way of treating mineral deficiencies is therefore desired. This invention proposes employing bioavailable minerals in a liquid complex that are pharmaceutically acceptable carriers including water.

### BACKGROUND OF THE INVENTION

Plants have mechanisms to contain and or eliminate attacks from Pathogens. They utilize a variety of methods to inhibit the development of pathogen. Insects, parasites, fungus, viruses, bacteria are subject to a variety of chemical changes that a plant may utilize to discourage the pathogen from replication leading to their consequential demise.

An early example is Man's use of salt to preserve food, the principle in the chemical composition is sodium, a metal.

A plant with adequate mineral availability will adjust the transport mechanisms within the plant to mitigate attaches from pathogens. These are accomplished with REDOX (reduction-oxidation) and measured by the balance of pH & energy within the plant. To generate energy a plant requires minerals. Two dissimilar minerals in an electrolyte generate 1.5 volts and when cells operate in series, higher voltages. Through electrolysis a plant can separate minerals from compounds sufficient to maintain their energy requirements and a REDOX sweet spot (Eh4.5-pH6.50 and varies with each plant and the conditions within where it grows.

Other mechanisms active within a plant are: SOD (Superoxide Dismutase), ROS (Reactive Oxygen Species) requiring energy from mineral participation.

Plants can suffer from mineral deficiencies that result in undesirable states, including attack from pathogens. A variety of methods are known for treating these undesirable states, but none have been entirely satisfactory. An improved method for treating mineral deficiencies is therefore desired. The discussion above is merely provided for general background information and not intended to be used as an aid in determining the scope of the claimed subject matter.

### SUMMARY OF THE INVENTION

In one form of the invention there is proposed a composition of increasing productivity and reducing disease severity and insect damage in plants, using a protective cation mineral ligand carrier, that specifically releases the mineral to supply areas of the plant that require such a mineral(s);

whereas the ligand is preferentially ammonia or SOD;
whereas the minerals are preferentially zinc or copper cations; and
whereas the ligand cation complex is absorbed by diffusion into the plant and can then move freely throughout the internal plant circulation, without the cation binding to targets that do not have mineral deficiency for this cation.

Preferably the composition further includes other supporting plant nutrients such as botanical extracts, urea, plant hormones, vitamins, and mineral supplements necessary for plant heath.

In a further form of the invention there is proposed a method of supplementing nutritional intake of a living plant, the method comprising the steps of treating a plant with a composition, the composition being formed by:
a. preparing a solution of ammonium hydrogen sulphate ((NH₄) HSO₄) using sulfuric acid (H₂SO₄);
b. diluting the ammonium hydrogen sulphate with water to form a mixture;
c. adding sulfuric acid;
d. adding a solution iron sulphate (FeSO₄) and water
e. adding a solution manganese sulphate (MgSO₄) and water
f. adding a solution zinc sulphate (ZnSO₄) and water
g. adding a solution copper sulphate (CuSO₄) and water
h. agitating the mixture until the ammonium hydrogen sulphate, the sulfuric acid, the water, the manganese sulphate, the iron sulphate, the copper sulphate and the zinc sulphate are blended together to form a zinc metal-ligand complex comprising a first plurality of ammonia ligands and a copper metal-ligand complex comprising a second plurality of ammonia ligands;
i. the mixture forming the composition.

In preference the method further comprises:

adding at least one delivery agent to the composition prior to the step of treating, the delivery agent selected from the group consisting of a surfactant, dimethyl sulfoxide, a urea-based compound, a detergent, a hygroscopic compound and combinations thereof.

In preference the ratio of zinc to copper is 7:2.

In preference the composition has a pH of less than 1.0.

In preference the method further comprises a step of analyzing the plant to determine a specific nutrient required and wherein the composition further includes a nutrient matched to the specific nutrient required.

In preference the composition further includes at least one of manganese, magnesium, cobalt, chromium, molybdenum, selenium, and vanadium.

In preference the composition further includes at least one of a plant hormone, an auxin, or a plant extract.

Ina further form of the invention there k proposed a method of supplementing bio-mineral nutritional intake of a healthy, living plant, the method comprising steps of treating a healthy plant with a composition, the composition being formed by:
j. preparing a solution of ammonium hydrogen sulphate ((NH₄) HSO₄) using sulfuric add (H₂SO₄);
k. diluting the ammonium hydrogen sulphate with water to for a mixture;
l. adding solutions of manganese sulphate and water, iron sulphate and water, zinc sulphate (ZnSO₄) and water, copper sulphate (CuSO₄) to the mixture, wherein the ratio of zinc to copper to manganese to iron is 7:2:1:1;
m. agitating the mixture until the ammonium hydrogen sulphate, the sulfuric acid, the water, the solution of copper sulphate and the solution of zinc sulphate are blended together to form a zinc metal-ligand complex comprising a first plurality of ammonia ligands and a copper metal-ligand complex comprising a second plurality of ammonia ligands;
n. further diluting the mixture with water to form the composition, wherein the composition has a pH of less than 1.0.

In preference the step of treating the healthy plant comprises one or a combination of the following:

spraying the plant, injecting into the plant, applying drip application, or irrigation.

In preference the step of treating the healthy plant comprises adding the composition to soil at the base of the plant.

In preference the composition further comprises urea.

In preference upon introduction to the plant, the composition bonds with a super oxide dismutase composition and is transported to mineral-deficient parts of the plant.

In preference the composition further includes at least one of manganese, magnesium, cobalt, chromium, molybdenum, selenium, and vanadium.

In preference wherein the composition further comprises at least one of a plant hormone, an auxin, or a plant extract.

### BRIEF DESCRIPTION OF THE DRAWINGS

Preferred features, embodiments and variations of the invention may be discerned from the following Detailed Description which provides sufficient information for those skilled in the art to perform the invention. The Detailed Description is not to be regarded as limiting the scope of the preceding Summary of the Invention in any way. The Detailed Description will refer to several drawings as follows.

FIGS. 1A, 1B, and 1C (generally FIG. 1) provide a comparison of cotton recovery after 8 days after the application of the solution according to the present invention.

FIG. 2 is a comparison of pea plant recovery after 8 days after an application of the patented solution. These plants were infected with leaf consuming Thrip and Aphids. These plants exhibited recovery with increased growth from these pathogens.

FIG. 3 is a table depicting REDOX the relationship of Electrical Charge (Eh) to Acid-Alkalinity (pH). The shaded area is the general sweet spot for optimal plant development. This varies with specific plants. Also, pathogens have a preferred sweet spot. By using the patented solution, we adjust the redox in a plant to the sweet spot whereby the plant is able to mitigate pathogens.

FIG. 4 is the production flow chart. This method reduces the heat generated from exothermic reactions when combining these elements.

### BRIEF DESCRIPTION OF THE INVENTION

The following detailed description of the invention refers to the accompanying drawings. Wherever possible, the same reference numbers will be used throughout the drawings and the following description to refer to the same and like parts. Dimensions of certain parts shown in the drawings may have been modified and/or exaggerated for the purposes of clarity or illustration.

A composition for treating mineral deficiencies in plants includes at least one complex cat-ion and inorganic coordination complexes formed by the coordinate bond formation between an electropositive mineral cat-ion (positive) and molecular groups that have un-shared electron pairs. The ammonia ligand configuration also acts as an artificial super-oxide dismutase (SOD) which acts as a free oxygen scavenger to alleviate plant stress, for example, under drought and mechanical damage.

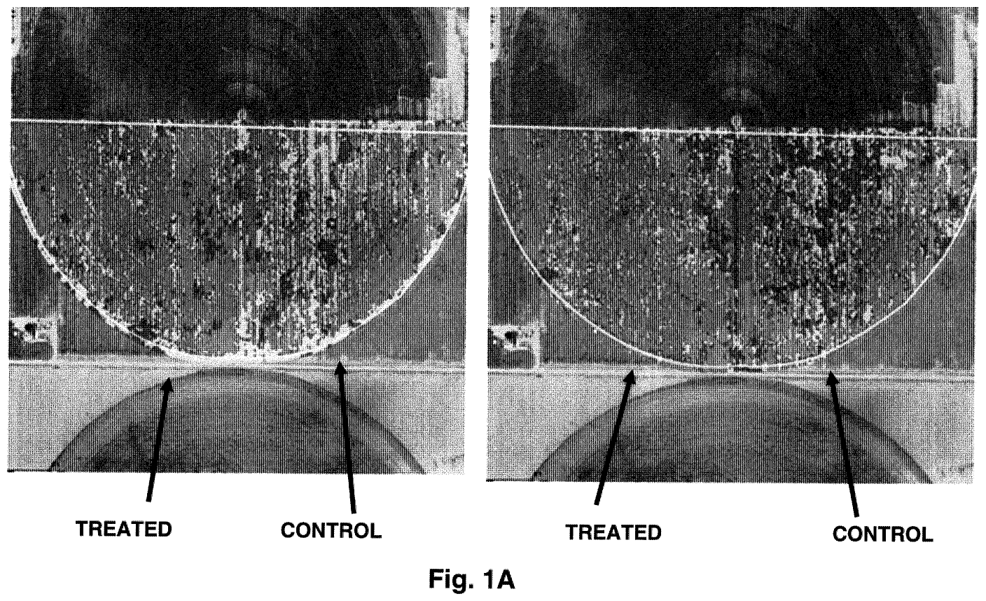

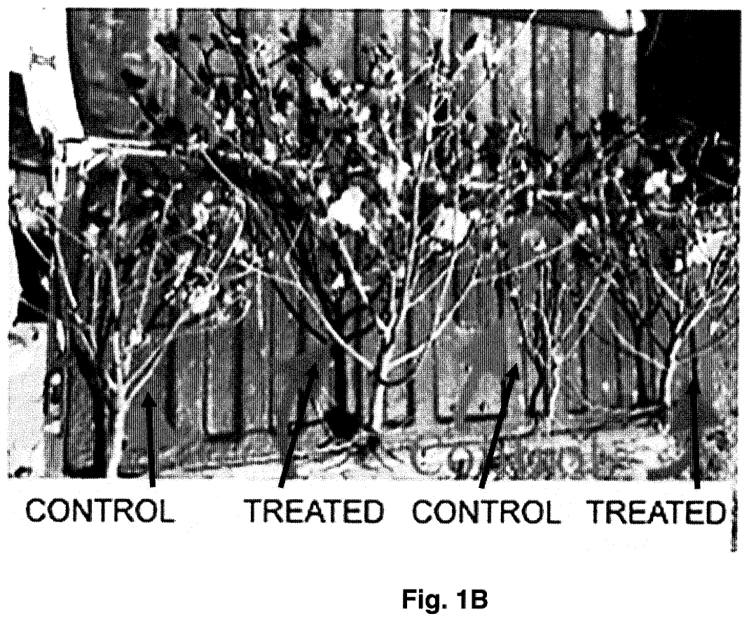

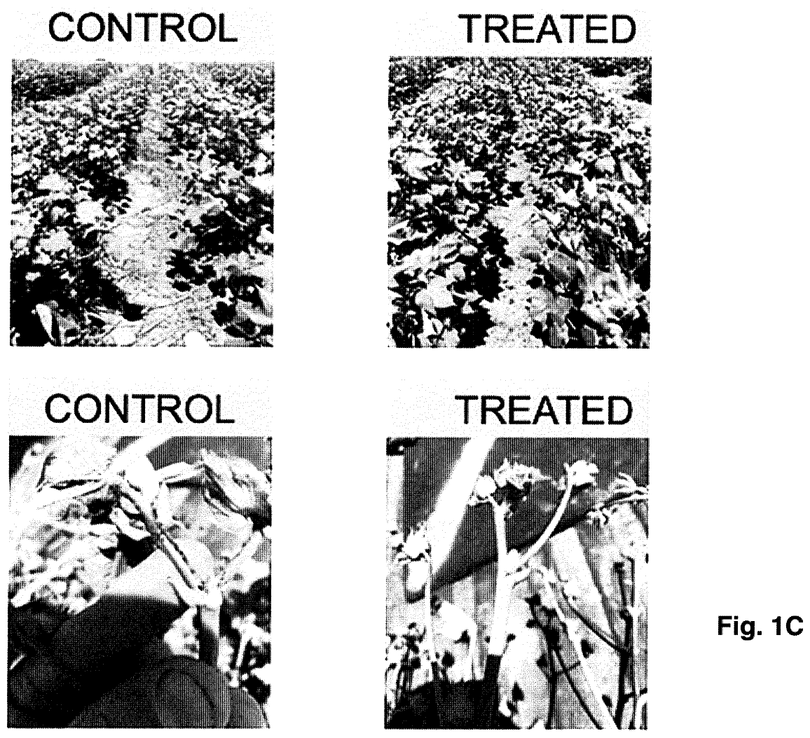

Referring to FIGS. 1A & 1B, these are the results of trails on cotton in Texas, USA. It is a comparison of cotton recovery after 8 days after the application of the solution the subject of the present application. These plants were infested with Boli worms and Army worms. These plants exhibited recovery with increased growth from these pathogens

Testimonials have reported beneficial results in the treatment of insects and worms after days. These results indicate an extended deterrence against various plant issues; including grasshoppers, aphids, and worms with no detrimental effect to pollinators. These preliminary results suggest that a plant with balanced nutrition particularly Zinc & Copper, Sulphur is able to create its own resistances and deterrents.

With reference to FIG. 1C it shows the results of younger cotton in the treated areas obviously being much healthier producing larger fruit than the untreated areas. Unusual for this region, this crop had an infestation of boll worms and beet army worms consuming leaf tissue. The treated vs control was that there were no aphids, worms and thrip in the treated areas.

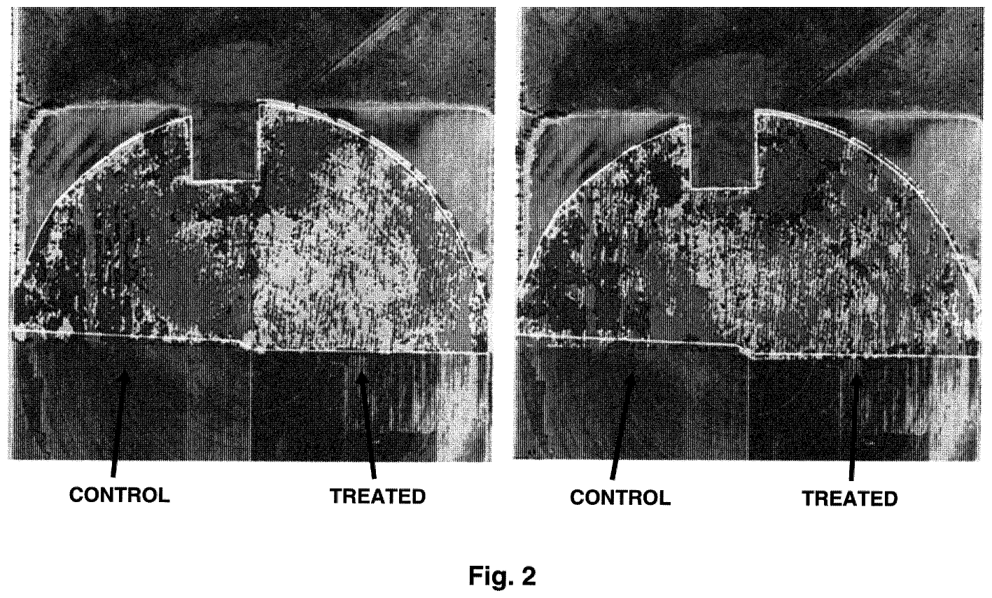

Referring to FIG. 2, it is a comparison of pea plant recovery after 8 days after an application of the solution. These plants were infected with leaf consuming Thrip and Aphids. These plants exhibited recovery with increased growth from these pathogens.

Despite this the product treated area was showing signs of recovery. An earlier application would have prevented this destruction

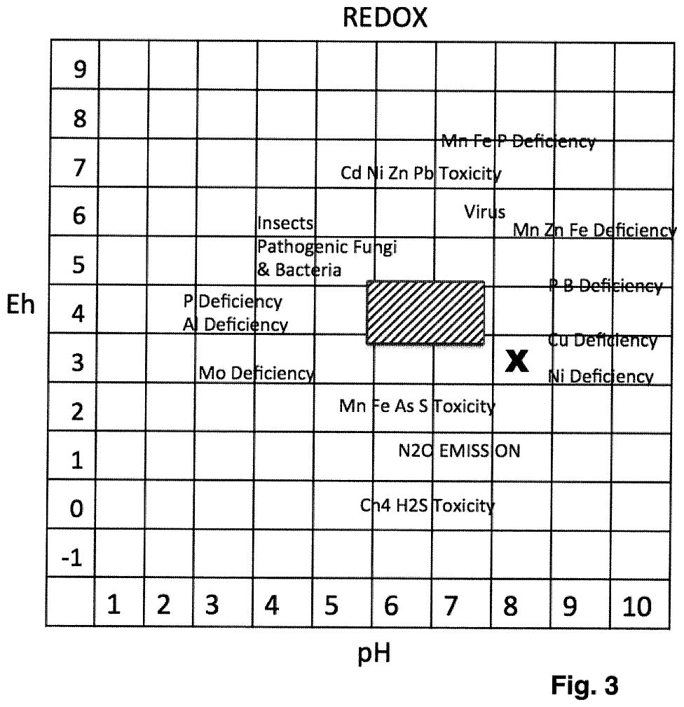

With reference to FIG. 3 this illustrates REDOX the relationship of Electrical Charge (Eh) to Acid-Alkalinity (pH). The shaded rectangular area is the general sweet spot for optimal plant development. This varies with specific plants. Also, pathogens have a preferred sweet spot. By using the patented solution, we adjust the redox in a plant to the sweet spot whereby the plant can mitigate pathogens.

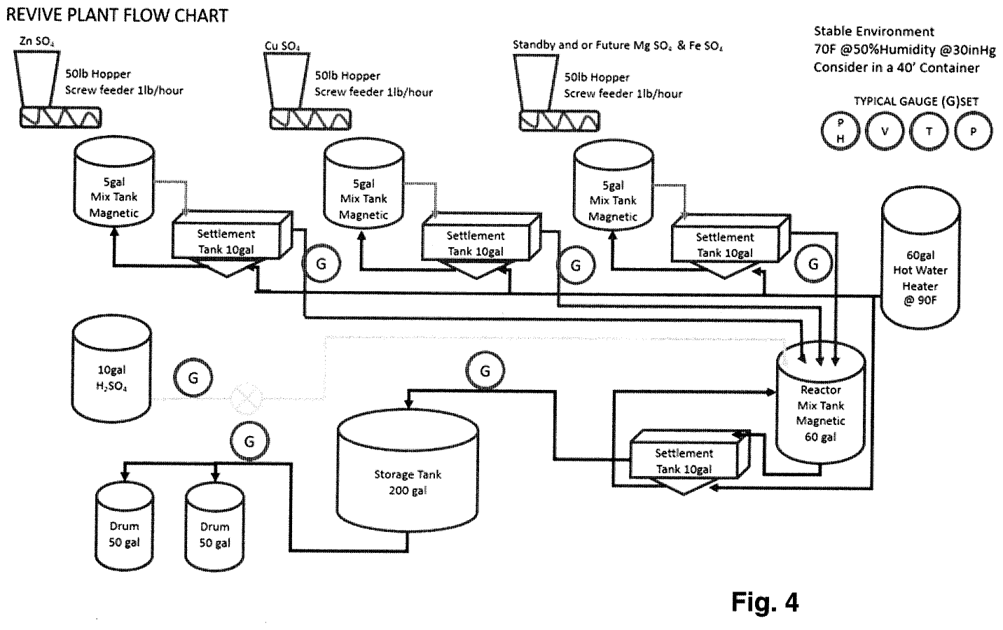

The flow chart in FIG. 4 illustrates the method of production where elements are combined to manufacture the formulation.

The product formulation as manufactured provides a delivery system for moving mineral ions to the mineral deficient areas in plants using highly bioavailable cat-ions through a complex ligand system. Ammonia ligands form a bond with the free metallic ions, especially zinc and copper to regions of the plant that require such minerals. Other minerals to be named follow the same pattern of dispersal throughout the plant in a systemic nature. The plant's natural metabolism will discard excess metals as described in the metabolic pathway's descriptions although an over-whelming amount of the composition is possible and may cause necrosis in the plant. The ionic nature of the formulation allows easy access to areas of the plant with deficiencies and provides a formulation that is stress. Faster germination of seeds and sprouts emergence from the growth medium, with increased plant biomass. Systemic delivery of targeted, and minerals to crops to create more robust plants and more nutritious crops. Increased ability in nutritional quality of cereal grains and produce, including the potential to engineer nutrition into our food; (e.g. bio-fortifying lettuce and grapes with zinc, potassium, and calcium). Benefits to crops accomplished organically, without the use of additive or subtractive genetic modify-techniques and is therefore considered non-GMO. Significantly smaller quantities of additive minerals and growth compounds compared to conventional farming of high yield crops. Organic formula and dilute application requirements should substantially reduce economic, social, ecological, and regulatory concerns associated with runoff into water sources. Use of less water compared to conventional farming methods. The ability to deploy self-contained crop growth systems for use in hostile environments such as the polar regions, deserts, underwater habitats, and other extreme locations. The disclosure further provides a method of reducing the time to maturity and harvest comprising supplementing nutritional intake of a living plant by the disclosed method. The disclosure further provides a method of increasing farm yields for food crops comprising supplementing nutritional intake of a living plant by the disclosed method. The disclosure further provides a method of creating more robust plants and more nutritious crops by systemic delivery superior to current technologies.

The present disclosure relates to a method of supplementing nutritional intake of a living plant, the method comprising steps of: treating a plant with a composition, the composition being formed by: adding ingredients of water, H₂SO₄, (NH₄) of targeted nutrients and minerals to crops comprising supplementing nutritional intake of a living plant by the dis-closed method. The disclosure further provides a method of increasing the nutritional quality of cereal grains and produce, including the SO₄ copper and zinc into a mixture; agitating the mixture until the ingredients are blended together; diluting the mixture with water to form the composition.

The present disclosure relates to a method of supplementing nutritional intake of a healthy, living plant, the method comprising steps of: treating a healthy plant with a composition, the composition being formed by: adding ingredients of water, H₂SO₄, (NH₄)₂SO₄, copper and zinc into a mixture; agitating the mixture until the ingredients are blended together; diluting the mixture with water.

It has been surprisingly found that the disclosed methods, which utilize a bioavailable mineral composition comprising water, H₂SO₄, (NH₄)₂SO₄, copper and zinc leads to many positive effects in plants, for example healthy plants, and in particular in food crop plants. Plants treated according to the disclosed method have been found to be faster growing, healthier and/or more robust. Additionally, the disclosed method may allow for fewer applications of the treatment compared to other known mineral treatments (for example PHYTO-PLUS Zinc Shotgun treatment or NPK treatment) leading to considerable cost and time savings. The benefits of the disclosed methods for supplementing nutritional intake in living plants may be summarized as including one or more of:
Faster time to maturity and harvest, with higher farm yields for food crops
Improved germination of seeds under conditions of abiotic stress
Faster germination of seeds and sprout emergence from growth medium
Increased biomass of plants
Systemic delivery of targeted nutrients and minerals to crops to create more robust plants and more nutritious crops
Ability to increase the nutritional quality of cereal grains and produce, including the potential to engineer nutrition into our food (e.g. bio-fortifying lettuce and grapes with zinc, potassium, and calcium)
Benefits to crops accomplished organically, without the use of additive or subtractive genetic modification techniques and is therefore considered non-GMO
Significantly smaller quantities of additive minerals and growth compounds compared to conventional farming of high yield crops
Organic formula and dilute application requirements should substantially reduce economic, social, ecological, and regulatory concerns associated with runoff into water sources
Use of less water compared to conventional farming methods
The ability to deploy self-contained crop growth systems for use in hostile environments such as the polar regions, deserts, underwater habitats, and other extreme locations.

The disclosure further provides a method of reducing the time to maturity and harvest comprising supplementing nutritional intake of a living plant by the disclosed method.

The disclosure further provides a method of increasing farm yields for food crops comprising supplementing nutritional intake of a living plant by the disclosed method.

The disclosure further provides a method of creating more robust plants and more nutritious crops by systemic delivery of targeted nutrients and minerals to crops comprising supplementing nutritional intake of a living plant by the disclosed method

The disclosure further provides a method of increasing the nutritional quality of cereal grains and produce, including the potential to engineer nutrition into our food (e.g. bio-fortifying lettuce and grapes with zinc, potassium and calcium), comprising supplementing nutritional intake of a living plant by the disclosed method.

The disclosure further provides a method of using less water compared to conventional farming methods comprising supplementing nutritional intake of a living plant by the disclosed method.

The disclosure further provides self-contained crop growth systems for use in hostile environments such as the Polar Regions, deserts, underwater habitats, and other extreme locations, comprising supplementing nutritional intake of a living plant by the disclosed method.

### Mode of Operation

The composition uses ionic mineral complexes that are capable of penetrating through plant parts including stems, leaves and roots while having little adverse effect on normal cell operations. Further, ionic mineral complexes are capable of penetrating cell membranes at a rapid pace through simple diffusion.

### Manufacturing Process

The manufacturing process described below produces a complex having ammonia ligand bonds with specific cat-ions. The cat-ions are carried by the ligand bonds and protected from being immediately bonded with the first available negative ions thus enabling free movement between and within the cells of the plant. Each of the minerals will be processed in the acid/base solution resulting in products that have a high acidity value, yet not being corrosive to living tissue. A noticeable concentration of reactive ammonia is also produced by the acid/base reaction. Complex cat-ions and inorganic coordination complexes are formed that can move the cat-ions in a relatively stable fashion and allow transport throughout the plant

### Bioavailable Minerals for Plant Health

A solution containing a mix of the prepared mineral(s) may contain only one of the minerals and additional supplements or all the mentioned minerals plus selected supplements to achieve the desired effect. For example, a zinc deficiency may only require zinc and a small amount of copper to balance (Mineral Inter-relationships) the effect of the possibility of too much zinc and other supplements (urea for example) to reinforce the effect of the mineral. All the minerals will act independent of one another much as gases do in Dalton's Law and be assimilated by the plant on an as-needed basis. For example, copper and zinc can be antagonistic to one another in a plant, but the two minerals can be put into the formulation at the right proportions and counter act the influence of one against the other. The copper and zinc also act to counterbalanced each other physiologically on a basis of 7:2 mole ratio (zinc to copper) and with the ammonia (NH3) form the product the subject of this invention, a form of ligand complex. The ligand travels through the selective membrane (epidermis) and travels through the plants xylem and/or phloem to a mineral deficient tissue where a physiological change will occur and the minerals are un-encapsulated from the ligand complex and are usable as part of the metabolic pathway in the plant.

The ligand formation is obtained during manufacture. However, the use of the ionic mineral in the formulation can be utilized to form an artificial superoxide dismutase (SOD). Plants normally form SODs however since silicon is necessary in most higher plants and is needed in grasses and other plants to support the structure. An example of incorporation of the product as described with reference to the superoxide dismutase (SOD) cycle will use copper (Cu) and zinc (Zn). The product will be incorporated into the SOD on an as needed basis and attached to the mineral complex to make a Cu-SOD, a Zn-SOD, or a Cu/Zn-SOD. The enzyme superoxide dismutase catalyzes dismutation of super oxide into oxygen and hydrogen peroxide. Therefore, it is an important antioxidant defense in almost all cells exposed to oxygen. The SOD catalyzed dismutation of super oxide may be written using the following half reactions:

M(″+¹)+SOD+O²-M(″.)+SOD+O

M(+)+SOD+o²+2H+-M(″+¹)+SOD+H₂O₂

Where M may be, but is not limited to:

(a) Cu(n=1); (b) Zn (n=2); (c) Mn(n=2); Fe(n=2); (e) Ni(n=2).

In this reaction the oxidation state of the metal cat-ion oscillates between n and n+l. Several common forms of SOD 55 exist and are proteins co-factored with copper (Cu) and zinc (Zn), manganese (Mn), iron (Fe) or nickel (Ni). Cytosols of almost all eukaryotic cells contain SODs and combine with copper and zinc (Cu—Zn-SOD)s. The Cu—Zn SOD and design is a homodimer of molecular weight of approximately 32,500. The Cu and Zn are joined primarily by hydrophobic and electrostatic interactions. The ligand complexes of cop-per and zinc are histidine side chains whereas the ligand complexes of manganese ions are three histidine side chains. The incorporation of the ligand complex into the SOD enables the ligand complex to travel throughout the plant in a protected form and without compromising the effectiveness of the ligand complex. Once the SOD with the ligand complex reaches a target cell the cat-ion within the ligand complex is released into the cell.

The resulting formulation can be prepared in many ways for application and will vary with the intended use. Formulations prepared for treatment for plant mineral deficiency will require selection of the proper formulation containing the necessary minerals. The formulations are stable at a pH near or below pH 1.0 in a wide variety of carriers. However, the active composition is prepared using the liquid. Additionally, the low pH of the composition may be diminished if the composition crystallizes.

The mineral cat-ion ingredients in the active composition will vary in proportion depending on the intended use and be added in certain formulation depending on the type and purpose thereof. The added inert ingredients used in the formulation will also vary considerably depending on the site and purpose of the application. Other active compounds may be added if the proposed components prove to be beneficial to the formulation. However, the basic ingredients are known to be effective without any additional components.

Additional elements may be added to the composition that aid in the overall effectiveness of the formula. For example, plant extracts and urea have demonstrated additional effectiveness for certain plant groups. Auxins and plant hormones may be useful for specific uses such as plant propagation techniques.

### Method of Application of Minerals to Target Sites

Treatment of mineral deficiencies and/or promoting general health of the plant may be carried out by topical application, hydroponics, nutrient film techniques or application to the roots and soil at the base of the plant. The composition can also be applied as an injectable into trees in the xylem and phloem for distribution throughout the plant. In cases where there is a special effort to incorporate minerals into a plant to ensure absorption the plant seeds, bulbs, tubers, suckers or other plant parts used in the propagation of a plant may be soaked, sprayed, drenched or submerged in a diluted solution (1:2 and above). The emerging plant can be watered by spraying, misting, drenching directly or by means of irrigation, drip application, hydraulic sprayers, ultra-low volume (ulv) sprays by ground or by aircraft. Periodic applications may be necessary in areas of high rain fall, high transpiration of plants or frequent stripping of fruit, leaves, grains, or other usable parts of the plant to insure proper growth and survival of the plant especially in areas with poor soils. The continual replenishment of the formulation in hydroponic, nutrient film and other liquid systems not only in the fluids but also to the top of the plant is possible since the formulation is systemic even to the dermal surface of leaves and other plant structures.

The formulation can also be applied as a “spike” loaded with the formulation next to the plant by itself or in a matrix around the plant or plants. The spikes can be recharged by application of more liquid formulation at intervals or a porous material containing the formulation. The formulations can also be incorporated into gels and agars for use in replicating undifferentiated plant cells on orbit or on terra firma or starting plants from single apical, brachial or other meristem cells. Special formulations in gels, agar or like substances can be used in formulations for starting seedlings on their way or in rooting cuttings, splicing rootstocks to new varieties or attaching cuttings to stems.

### CONCLUSIONS

The product the subject of this specification has a significant and positive effect on reduction of pathogen attack by increasing the plants responses by discouraging a pathogen's preference as a reproduction environment. The product aids plants with early root formation of seedlings. There is also an uptake on minerals with the soil bound up as salts. The product may accelerate maturation rate of seedlings, due to more roots, and better access to nutrients/water and aids plants with recovery from pathogen attack. With optimal concentration, the product can be customized to fit the critical need of the crop, balancing root development with production of leaves for photosynthetic energy capture, mitigating pathogen attack.

Further advantages and improvements may very well be made to the present invention without deviating from its scope. Although the invention has been shown and described in what is conceived to be the most practical and preferred embodiment, it is recognized that departures may be made therefrom within the scope of the invention, which is not to be limited to the details disclosed herein but is to be accorded the full scope of the claims so as to embrace any and all equivalent devices and apparatus. Any discussion of the prior art throughout the specification should in no way be considered as an admission that such prior art is widely known or forms part of the common general knowledge in this field.

In the present specification and claims (if any), the word “comprising” and its derivatives including “comprises” and “comprise” include each of the stated integers but does not exclude the inclusion of one or more further integers.

1. A composition of increasing productivity and reducing disease severity and insect damage in plants, using a protective cation mineral ligand carrier, that specifically releases the mineral to supply areas of the plant that require such a mineral(s);
whereas the ligand is preferentially ammonia or SOD;
whereas the minerals are preferentially zinc or copper cations; and
whereas the ligand cation complex is absorbed by diffusion into the plant and can then move freely throughout the internal plant circulation, without the cation binding to targets that do not have mineral deficiency for this cation.

2. The composition as in claim 1 further including other supporting plant nutrients such as botanical extracts, urea, plant hormones, vitamins, and mineral supplements necessary for plant heath.

3. A method of supplementing nutritional intake of a living plant, the method comprising the steps of treating a plant with a composition, the composition being formed by:
a. preparing a solution of ammonium hydrogen sulphate ((NH₄)HSO₄) using sulfuric acid (H₂SO₄);
b. diluting the ammonium hydrogen sulphate with water to form a mixture;
c. adding sulfuric acid;
d. adding a solution iron sulphate (FeSO₄) and water
e. adding a solution manganese sulphate (Mg SO₄) and water
f. adding a solution zinc sulphate (ZnSO₄) and water
g. adding a solution copper sulphate (CuSO₄) and water
h. agitating the mixture until the ammonium hydrogen sulphate, the sulfuric acid, the water, the manganese sulphate, the iron sulphate, the copper sulphate and the zinc sulphate are blended together to form a zinc metal-ligand complex comprising a first plurality of ammonia ligands and a copper metal-ligand complex comprising a second plurality of ammonia ligands;
i. the mixture forming the composition.

4. The method as in claim 3, further comprising:
adding at least one delivery agent to the composition prior to the step of treating, the delivery agent selected from the group consisting of a surfactant, dimethyl sulfoxide, a urea-based compound, a detergent, a hygroscopic compound and combinations thereof.

5. The method as in claim 3, wherein the ratio of zinc to copper is 7:2.

6. The method as in claim 3, where the composition has a pH of less than 1.0.

7. The method as in claim 3, further comprising a step of analyzing the plant to determine a specific nutrient required and, wherein the composition further includes a nutrient matched to the specific nutrient required.

8. The method as in claim 3, wherein the composition further includes at least one of manganese, magnesium, cobalt, chromium, molybdenum, selenium, and vanadium.

9. The method as in claim 3, wherein the composition further includes at least one of a plant hormone, an auxin, or a plant extract.

10. A method of supplementing bio-mineral nutritional intake of a healthy, living plant, the method comprising steps of treating a healthy plant with a composition, the composition being formed by:
a. preparing a solution of ammonium hydrogen sulphate ((NH₄) HSO₄) using sulfuric acid (H₂SO₄);
b. diluting the ammonium hydrogen sulphate with water to for a mixture;
c. adding solutions of manganese sulphate and water, iron sulphate and water, zinc sulphate (ZnSO₄) and water, copper sulphate (CuSO₄) to the mixture, wherein the ratio of zinc to copper to manganese to iron is 7:2:1:1;
d. agitating the mixture until the ammonium hydrogen sulphate, the sulfuric acid, the water, the solution of copper sulphate and the solution of zinc sulphate are blended together to form a zinc metal-ligand complex comprising a first plurality of ammonia ligands and a copper metal-ligand complex comprising a second plurality of ammonia ligands;
e. further diluting the mixture with water to form the composition, wherein the composition has a pH of less than 1.0.

11. The method as in claim 10, wherein the step of treating the healthy plant comprises one or a combination of the following:
spraying the plant, injecting into the plant, applying drip application, or irrigation.

12. The method as in claim 10, wherein the step of treating the healthy plant comprises adding the composition to soil at the base of the plant.

13. The method as in claim 10, wherein the composition further comprises urea.

14. The method as in claim 10, wherein upon introduction to the plant, the composition bonds with a super oxide dismutase composition and is transported to mineral-deficient parts of the plant.

15. The method as in claim 10, wherein the composition further includes at least one of manganese, magnesium, cobalt, chromium, molybdenum, selenium, and vanadium.

16. The method as in claim 10, wherein the composition further comprises at least one of a plant hormone, an auxin, or a plant extract.
